(19) United States
(12) Patent Application Publication
(10) Pub. No.: US 2021/0213672 A1
(43) Pub. Date: Jul. 15, 2021

(54) SCREEN PROTECTOR APPLICATOR AND METHOD

(71) Applicant: FELLOWES, INC., Itasca, IL (US)

(72) Inventors: Garrett Chou, Northbrook, IL (US); Aatish Patel, Bloomingdale, IL (US); Benjamin MacBeth, Elmhurst, IL (US)

(21) Appl. No.: 17/149,387

(22) Filed: Jan. 14, 2021

Related U.S. Application Data
(60) Provisional application No. 62/961,139, filed on Jan. 14, 2020.

(51) Int. Cl. B29C 63/00; B29C 63/02

(52) U.S. Cl. CPC B29C 63/0004; B29C 63/02; B29L 2031/3437; B29C 2063/0008; B29C 63/0047

(57) ABSTRACT

An apparatus to aid in applying a screen protector to the display of a mobile electronic device such as a smartphone. The apparatus in some embodiments is a wedge or ramp that is placed between the display and the screen protector to support a portion of the screen protector above the display. The user may withdraw or move the wedge or ramp and tip the screen protector onto the display. The wedge or ramp may have a plurality of profiles or surfaces on which the screen protector rides as the wedge is moved, the profiles or slope of the surface aiding in controlling the rate at which the screen protector descends onto the display. The apparatus may also include a frame to go about the perimeter of the mobile device to aid in positioning the screen protector. The frame may include alignment aids and absorbent material about the perimeter of the mobile device.

### BACKGROUND OF THE INVENTION

### Field of the Invention

The invention relates to screen protectors for the displays of mobile electronic devices. The invention includes a frame and applicator or positioning device for applying or positioning a screen protector onto the display of a mobile electronic device such as a cell phone.

### Background Art

Screen protectors for cell phones and other electronic devices are well known. Such protectors typically include or utilize a factory applied optically clear adhesive to attach the screen protector to the display of the cell phone. However, it is often a challenge for the user to accurately align or register the screen protector with the display of the device. Further, as the protector is placed upon the screen, dust and air bubbles can be trapped between the display and the screen protector.

To improve the application process, user applied liquid optically clear adhesives have been used, whereby the end user applies a liquid adhesive to the cell phone display, and then applies the screen protector. The adhesive however can be misapplied or mispositioned, resulting in a waste of adhesive and undesired distribution of adhesive onto other areas of the cell phone.

Such prior art arrangements can also include shims to aid the user in placing the screen protector onto the liquid adhesive, but often the shims simply drop the screen protector on the liquid adhesive when the shims are removed. This dropping or free fall of the screen protector onto the liquid adhesive causes variability in the application of the screen protector. The dropping also increased the occurrence of trapped air bubbles between the display and screen protector.

### SUMMARY OF THE INVENTION

The invention includes an applicator frame to fit or conform about the perimeter of the cell phone display. The frame includes an opening to allow the screen protector to be properly aligned with the display and placed upon and guided into position on the display. The frame thus provides a fixed area in which to place or position the screen protector, insuring proper alignment with the display. The frame may be made of any suitable material, such as metal, plastic, or composite.

The applicator frame may include an absorbent layer about the interior perimeter of the frame so that the absorbent layer may absorb, collect, or prevent run-off of adhesive onto any non-display portions of the device where it could impair functions of the device or otherwise cause damage. The absorbent layer also acts to absorb adhesive from in-between the display and perimeter edges of the screen protector, resulting in a clean edge once the frame and absorbent layer are removed. In some embodiments, the frame may include channels or other structures to collect excess adhesive at the display perimeter.

The invention described herein also includes a wedge or other device to selectively lower or tip the screen protector onto the display. The wedge may include multiple profiles or surfaces along its length to allow for different inclines and drop rates of the screen protector. Such assembly may be used with screen protectors having pre-applied adhesive but is particularly useful when used with liquid adhesive. The wedge allows the rate and angle of placement of the screen protector onto the liquid adhesive to be varied and controlled, thus minimizing the occurrence or entrapment of air bubbled between the adhesive and the screen protector. The wedge described herein may act as a support for the protector prior to installation, a guide to lower the protector onto the liquid adhesive and display, and as a bubbling control device.

The variations in slope of the wedge surfaces are present to control the rate and angle at which the protector descends onto the adhesive. This controls the spreading or distribution of the liquid adhesive across the display and acts to direct any excess liquid adhesive to the perimeter of the display and to the absorbent layer of the frame.

For instance, it may be desirable for the wedge to have three slope sections. The first section controls the initial descent of the protector, where the protector first meets or interacts with the liquid adhesive placed on the display by the user. In order to prevent unwanted air to become entrapped and to prevent unwanted spreading of the liquid adhesive, the protector should be lowered in a continuous, gentle motion. To accomplish this, the wedge slope is relatively shallow in the first section.

Optimally, once the protector makes initial contact with the liquid adhesive, the rate of descent of the protector may be faster than the initial descent. This increase in the rate of descent ensures proper spreading of the adhesive and so that the liquid adhesive does not shift in location once initial contact is made. The alleviate any disruption in the spreading of the adhesive, it is preferred of the transition of slope from the first section to the second section is not abrupt. Hence, it is preferable that the differing slopes are joined or transitioned by a short curved section or profile.

The second section has a higher rate of decline when compared to the first section. The higher rate of decline in the second section enhances the initial spreading of the liquid adhesive.

The third section has a rate of decline or descent that is lower than that of second section. As with the transition from the first section to the second section, the transition from the second section to the third section may include a curved portion so that the transition is not abrupt. The greater rate of decline promotes the capillary spreading action of the adhesive between the protector and the display. The terminal end of the third section is rounded to allow the protector to fall off or disengage from the wedge in a continuous and smooth motion.

One skilled in the art will recognize that the surface of the wedge that rides on the frame may be the surface that is angled, shaped, profiled, or includes sloped sections or changes in slope to achieve the desired changes or variations in the rate of descent of the screen protector. However, it is preferred that the varied surface is the one the screen protector rides on, and that the frame wedge interface is constant or uniform to allow for the smooth movement of the wedge.

The rate at which the protector is lowered is dependent upon both the speed at which the wedge is withdrawn or moved, and the slope of the wedge surfaces on which the protector rides. One skilled in the art will recognize that different slopes, numbers of slopes, and configuration of slopes may be used. In some embodiments, it may be advantageous to use a series of curves. It should also be recognized that the configuration wedge and corresponding slopes or curves may be different for each model of phone or display, or screen protector. For instance, some screen protectors may bend or curve more when suspended above the display, thus affecting how the protector contacts the adhesive as the protector is lowered or descends onto the adhesive. Similarly, different screen protector materials may affect how the adhesive spreads and may require different wedge slopes to obtain the desired spreading. Similarly, different liquid adhesives may also require different wedges or profiles.

The frame and wedge of the present invention may be separate structures or incorporated into a combined assembly. The frame may include features such as notches, grooves, rails, or other structures to interact with, capture, or otherwise guide the wedge as a user slides or repositions the wedge across the frame to lower the screen protector onto the display.

In use, the frame is placed around at least a portion of the perimeter of the phone display. In the most preferred embodiment, the absorbent layer of the frame is adjacent to the perimeter of the display. A suitable quantity of the optically clear liquid adhesive is applied to the display or the protector, typically at a single location while the display is placed so that it is generally horizontal.

The wedge is placed on top of the frame such that at least a portion overhangs the opening over the display and positioned so that the wedge slopes down towards the display. Using the frame as a registration or alignment aid, a first end of the screen protector is then positioned to rest on the display distal from the location of the wedge and a second end of the display rests upon the wedge, thus suspending the screen protector above the adhesive and the display at an angle. Preferably the second end of the screen protector is resting upon the first section of the wedge slope.

The user then moves, withdraws, or repositions the wedge in a direction away from the opening in the frame. This movement allows the second end of the screen protector to move down the profiles of the wedge in succession, thus progressively reducing the angle between the screen protector and the display and promoting the spreading of the liquid adhesive as the angle is reduced.

As the wedge is withdrawn and the second end of the screen protector moves down or along the first slope of the wedge, the screen protector contacts the adhesive. As the second end of the screen protector moves along the second slope of the wedge, the adhesive spreads to the width of the display and contacts the lateral edges of the frame. As the second end of the screen protector moves along the third slope of the wedge, the adhesive is spread towards the wedge, filling the void between the display and the screen protector. Finally, the second end of the screen protector drops off the end of the wedge, placing the screen protector fully on the adhesive and the display. The frame is then removed from the phone or other electronic device.

In some embodiments, the screen protector may have a concave curvature. The concave curvature benefits capillary action and promotes the spreading of the adhesive, particularly in a direction away from the wedge.

In one form, the invention is directed to an apparatus for applying a screen protector to a display of a mobile electronic device. The apparatus includes a frame and a wedge. The wedge has a surface for supporting an edge of the screen protector.

In one form, the surface for supporting an edge of the screen protector includes a plurality of slopes.

In one form, the surface for supporting an edge of the screen protector has a portion having a first slope, a portion having a second slope, and a portion having a third slope.

In one form, the wedge is slidably coupled to the frame.

In one form, the frame has a perimeter portion. The perimeter portion includes an absorbent material.

In one form, the frame further has an alignment tab that extends from the frame.

In one form, the invention is directed to an applicator for applying a screen protector to a display of a mobile electronic device. The applicator has a first surface in contact with an edge of the screen protector when the applicator is in a first position. The first surface is at a first angle to the display. A second surface is in contact with the edge of the screen protector when the applicator is in a second position. The second surface is at a second angle to the display. A third surface is in contact with the edge of the screen protector when the applicator is in a third position. The third surface is at a third angle to the display.

In one form, the applicator further includes a frame for positioning the applicator on the mobile electronic device. The frame has a perimeter portion that goes about at least a portion of a perimeter of the mobile device.

In one form, the applicator first surface includes a first surface first lateral portion in contact with a first lateral portion of the edge of the screen protector. A first surface second lateral portion is in contact with a second lateral portion of the edge of the screen protector.

In one form, the frame includes an absorbent material about at least a portion of the perimeter of the mobile device.

In one form, the frame has an alignment tab that extends upward from the frame.

In one form, the invention is directed to an applicator for use in applying a screen protector to the display of a mobile electronic device. The applicator has a wedge and a frame. The wedge has a bearing surface for sliding on the frame and a screen protector bearing surface. The screen protector bearing surface including a first section having a first profile, and a second section having a second profile.

In one form, the screen protector bearing surface has a third section. The third section terminates in an arcuate end.

In one form, the third section is longer than the first section.

In one form, the frame includes a perimeter portion that has an absorbent.

In one form, the first section of the screen protector bearing surface is in contact with the screen protector when the wedge is in a first position relative to the frame. The second section of the screen protector bearing surface is in contact with the screen protector when the wedge is in a second position relative to the frame.

In one form, the wedge has a first lateral arm coupled to a first lateral portion of the frame. A second lateral arm is coupled to a second lateral portion of the frame.

In one form, a first alignment tab extends upward from the first lateral portion of the frame. A second alignment tab extends upward from the second lateral portion of the frame.

In one form, the first alignment tab includes an inner facing surface. The inner facing surface slopes inwards.

### BRIEF DESCRIPTION OF THE DRAWINGS

FIG. 1 is a perspective view of a frame and wedge of the present invention;

FIG. 2 is a side elevation of a frame and wedge of the present invention;

FIG. 3 is a side elevation of a frame and wedge of the present invention on a cell phone having a display and a suspended screen protector above the display;

FIG. 4 is a side elevation of a wedge showing example profiles;

FIG. 5 is a bottom view of a frame and wedge of the present invention;

FIG. 6 is a perspective view of an alternative embodiment of a frame and wedge of the present invention, the wedge having lateral portions;

FIG. 7 is a side elevation view of the alternate embodiment of the present invention;

FIG. 8 is a bottom view of the alternate embodiment of the present invention; and

FIG. 9 is a side elevation view of the alternate embodiment of the present invention.

### DETAILED DESCRIPTION OF THE PREFERRED EMBODIMENT

With reference to the Figures, the invention includes a frame 10 and a wedge 100 for applying a screen protector 1 to the display 5 of a mobile electronic device 8. The frame 10 includes a first perimeter portion 11 that goes about at least a portion of the perimeter of a cell phone or mobile electronic device 8. The frame includes a second perimeter portion 12 vertically offset from the first perimeter portion 11. The second perimeter portion 12 may also be horizontally offset from the first perimeter portion. In some embodiments, the second perimeter portion 12 may include an absorbent material adjacent to the display 5 when the frame 10 is mounted on the mobile electronic device 8.

In some embodiments of the invention, the frame 10 may include alignment tabs 20 extending upward from the frame 10. The alignment tabs 20 preferably extend upwards above the level of the screen protector 1 when the screen protector is positioned within the frame and on the wedge prior to application of the screen protector 1 to the display 5. In some embodiments, the inner facing surface 22 of the alignment tabs 20 slopes inward to improve placement of the screen protector 1 on the display 5. The inner facing surface 22 smoothly transitions to the inner perimeter portion 12 of the frame 10 so that the screen protector 1 does not hang or catch as it descends onto the display 5 or adhesive. In some embodiments, the frame includes gripping portion 19.

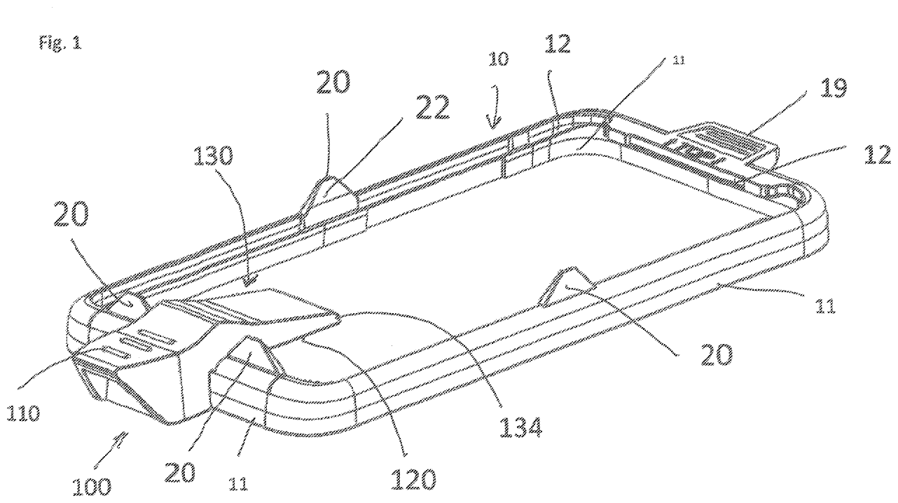

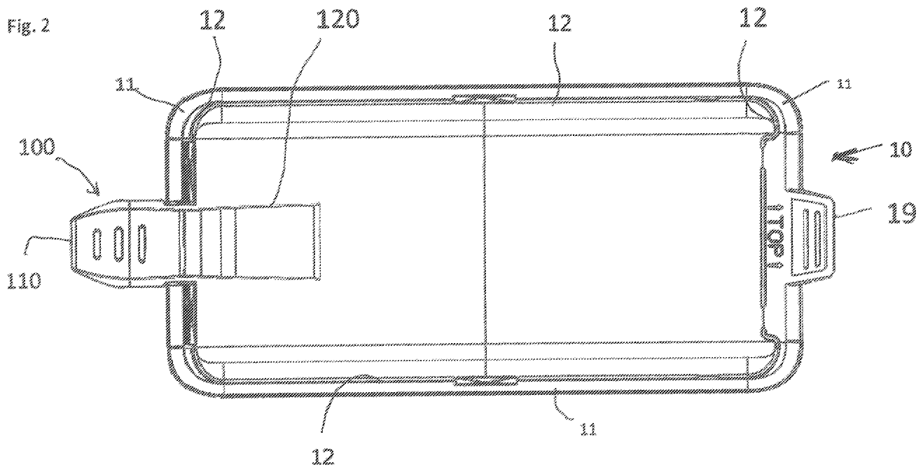

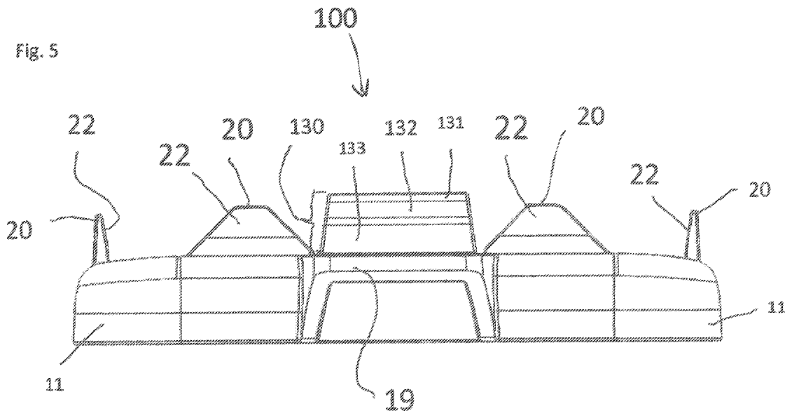

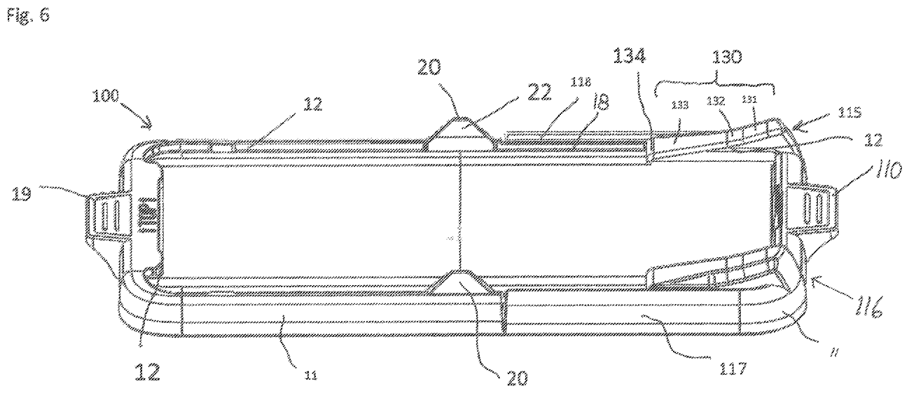

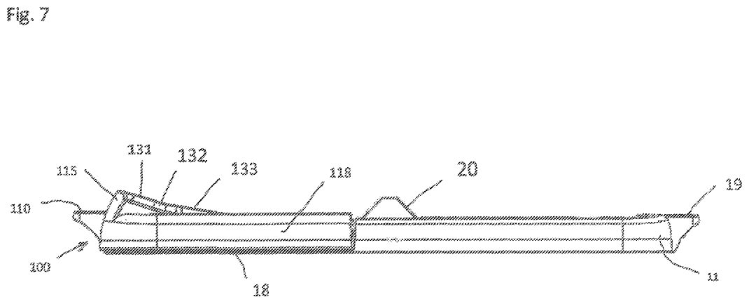

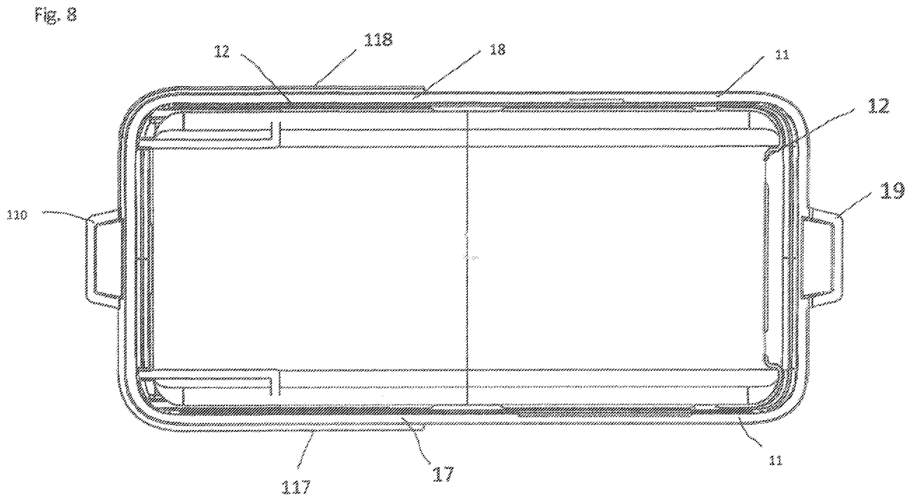

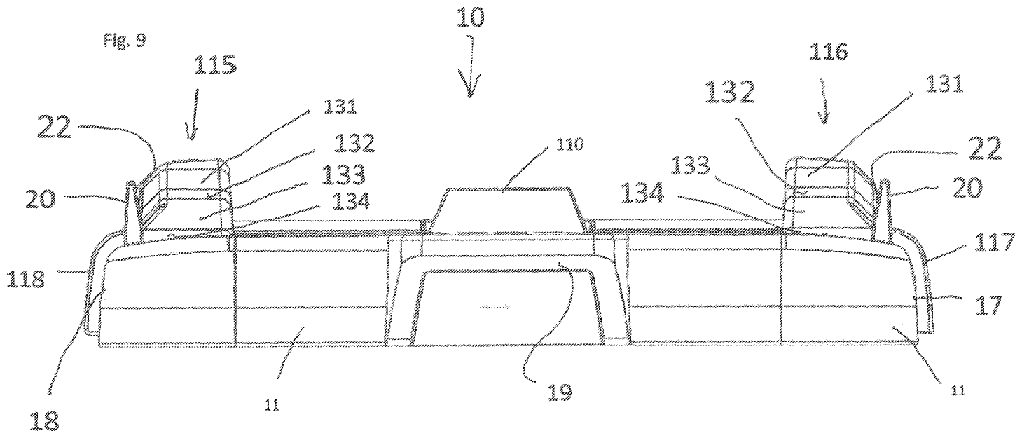

The wedge 100 may be slidable connected to the frame 10, or a non-coupled piece. As shown in FIGS. 1-5, the wedge 100 is a non-coupled piece. As shown in FIGS. 6-9, the wedge 100 is slidable coupled to the frame 10.

With reference to FIGS. 1-5, the wedge 100 includes a gripping portion 110 for gripping by the user. Also included is a bearing surface 120 for slidably bearing on the frame 10. Also included is a screen protector bearing surface 130. The screen protector bearing surface 130 is preferably sloped toward the opening in the frame 10 when the wedge 100 is placed on the frame 10.

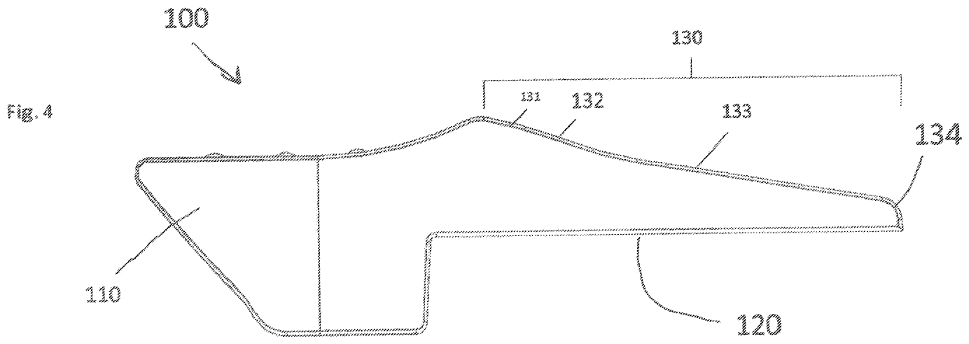

In the most preferred embodiment, the screen protector bearing surface 130 of the wedge 100 includes a plurality of sections each having its own slope, profile, or curvature. As best shown in FIG. 4, the screen protector bearing surface 130 has a first section 131, a second section 132, and a third section 133.

The first section 131 has a first slope or profile. The second section 132 has a second slope or profile. In the most preferred embodiment, the slope of the second section 132 is greater than the slope of the first section 131. In some embodiments of the invention, the transition between the first section 131 and the second section 132 is curved. In some embodiments of the invention the third section 133 has a slope that is less than the slope of the second section 132. In some embodiments of the invention, the transition between the second section 132 and the third section 133 is curved. The third section 133 preferably terminates in a rounded or arcuate end 134. In the most preferred embodiment of the invention, the third section 133 is the longest of the sections of the screen protector bearing surface 130.

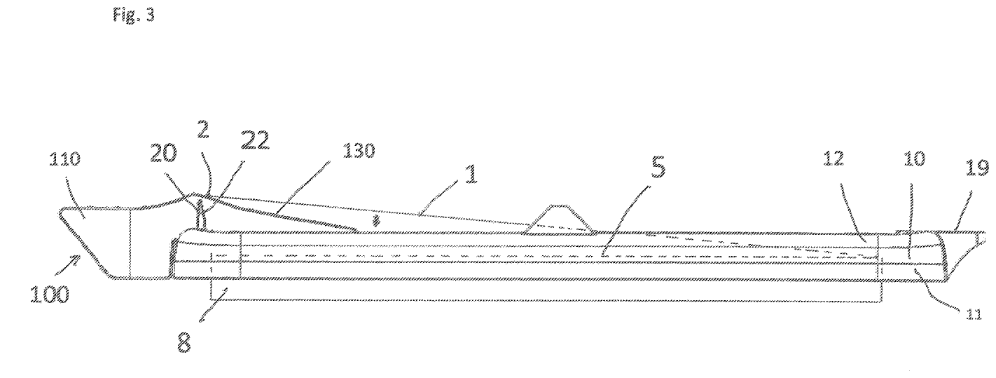

With reference to FIG. 3 and the arrows, in use the user grips the wedge 100 by the gripping portion 110 and smoothly slides the wedge 100 horizontally away from the frame 10, as shown by the arrow. The screen protector second end 2 moves down the screen protector bearing surface 130 without being displaced in the direction of the wedge 100, thus reducing the angle of incline of the screen protector 1. When the wedge 100 is fully moved, the second end 2 of the screen protector is no longer supported by the wedge 100, and the screen protector fully descends onto the adhesive and display 5.

With reference to FIGS. 6-9, and alternate embodiment is shown. The alternate embodiment shown is similar to the embodiments shown in FIGS. 6-9 but includes a wedge 100 that is slidably coupled to the frame 10. The wedge 100 includes gripping portion 110. The wedge 100 is further divided into lateral portions 115 and 116, rather than being centrally located to support the center of a perimeter edge of the screen protector 1. In the alternate embodiment, the screen protector 1 is supported at or near the lateral perimeter of the edge.

In some embodiments, the coupled wedge 100 includes lateral arms 117 and 118 including channels that engage with lateral portions 17 and 18 of the frame 10, allowing the wedge 110 to slide with respect to the frame 10 and remain aligned with the frame 10, improving registration of the screen protector 1 with the display 5 as the screen protector 1 descends.

The foregoing disclosure of specific embodiments is intended to be illustrative of the broad concepts comprehended by the invention.

1. An apparatus for applying a screen protector to a display of a mobile electronic device, the apparatus including a frame and a wedge, the wedge including a surface for supporting an edge of the screen protector.

2. The apparatus of claim 1, wherein the surface for supporting an edge of the screen protector includes a plurality of slopes.

3. The apparatus of claim 1, the surface for supporting an edge of the screen protector having a portion having a first slope, a portion having a second slope, and a portion having a third slope.

4. The apparatus of claim 1, wherein the wedge is slidably coupled to the frame.

5. The apparatus of claim 4, wherein the surface for supporting an edge of the screen protector includes a plurality of slopes.

6. The apparatus of claim 5, wherein the frame includes a perimeter portion, the perimeter portion including an absorbent material.

7. The apparatus of claim 6, the frame further including an alignment tab extending from the frame.

8. An applicator for applying a screen protector to a display of a mobile electronic device, the applicator including first surface in contact with an edge of the screen protector when the applicator is in a first position, the first surface being at a first angle to the display, a second surface in contact with the edge of the screen protector when the applicator is in a second position, the second surface being at a second angle to the display, and a third surface in contact with the edge of the screen protector when the applicator is in a third position, the third surface being at a third angle to display.

9. The applicator of claim 8, the applicator further including a frame for positioning the applicator on the mobile electronic device, the frame including a perimeter portion that goes about at least a portion of a perimeter of the mobile device.

10. The applicator of claim 8, the applicator first surface including a first surface first lateral portion in contact with a first lateral portion of the edge of the screen protector, and a first surface second lateral portion in contact with a second lateral portion of the edge of the screen protector.

11. The applicator of claim 9, wherein the frame includes an absorbent material about at least a portion of the perimeter of the mobile device.

12. The applicator of claim 9, wherein the frame includes an alignment tab extending upward from the frame.

13. An applicator for use in applying a screen protector to the display of a mobile electronic device, the applicator including a wedge and a frame, the wedge including a bearing surface for sliding on the frame and a screen protector bearing surface, the screen protector bearing surface including a first section having a first profile, and a second section having a second profile.

14. The applicator of claim 13, wherein the screen protector bearing surface includes a third section, the third section terminating in an arcuate end.

15. The applicator of claim 14, wherein the third section is longer than the first section.

16. The applicator of claim 14, wherein the frame includes a perimeter portion having an absorbent.

17. The applicator of claim 13, wherein the first section of the screen protector bearing surface is in contact with the screen protector when the wedge is in a first position relative to the frame, and the second section of the screen protector bearing surface is in contact with the screen protector when the wedge is in a second position relative to the frame.

18. The applicator of claim 17, wherein the wedge includes a first lateral arm coupled to a first lateral portion of the frame, and a second lateral arm coupled to a second lateral portion of the frame.

19. The applicator of claim 18, further including a first alignment tab extending upward from the first lateral portion of the frame, and a second alignment tab extending upward from the second lateral portion of the frame.

20. The applicator of claim 19, wherein the first alignment tab includes an inner facing surface, the inner facing surface sloping inwards.
